(19) United States
(12) Patent Application Publication
(10) Pub. No.: US 2019/0391969 A1
(43) Pub. Date: Dec. 26, 2019

(54) DIFFERENCE MANAGEMENT APPARATUS, STORAGE SYSTEM, DIFFERENCE MANAGEMENT METHOD, AND PROGRAM

(71) Applicant: NEC PLATFORMS, LTD., Kawasaki-shi, Kanagawa (JP)

(72) Inventor: Masahiro KOHNO, Kanagawa (JP)

(73) Assignee: NEC PLATFORMS, LTD., Kawasaki-shi, Kanagawa (JP)

(21) Appl. No.: 16/490,642

(22) PCT Filed: Mar. 16, 2018
(86) PCT No.: PCT/JP2018/010418

§ 371 Date: Sep. 3, 2019

(30) Foreign Application Priority Data
Mar. 17, 2017 (JP) 2017-053268

(51) Int. Cl. G06F 16/22; G06F 16/215

(52) U.S. Cl. CPC G06F 16/2282; G06F 16/215

(57) ABSTRACT

A difference management apparatus includes: a first difference management table which manages first difference map information; and a second difference management table in which, when an area-wide difference(s) has not occurred in a first management unit of the first difference management table, an entry(ies) for managing second difference map information associated with the first difference map information in the first difference management table is generated, the second difference map information indicating a location(s) of occurrence of a difference(s) in the first difference map information in a second management unit finer than the first management unit. If the second difference map information indicates an area-wide difference(s) as a result of an update of the second difference map information in the second difference management table, the difference management apparatus removes an entry(ies) corresponding to the second difference map information in which the area-wide difference(s) has occurred from the second difference management table.

### REFERENCE TO RELATED APPLICATION

This application is a National Stage Entry of PCT/JP2018/010418 filed on Mar. 16, 2018, which claims priority from Japanese Patent Application 2017-053268 filed on Mar. 17, 2017, the contents of all of which are incorporated herein by reference, in their entirety.

### FIELD

The present invention relates to a difference management apparatus, a storage system, a difference management method, and a program. In particular, it relates to a difference management apparatus, a storage system, a difference management method, and a program that manage an updated portion(s) of data as a difference(s).

### BACKGROUND

Patent Literatures (PTL) 1 discloses an example of a storage apparatus that manages a duplication generation number(s) corresponding to a pair(s) of duplication-destination logical storage apparatus and data-duplication-source logical storage apparatus associated with each other by using a difference map. When a correspondence relationship between a duplication source volume and a duplication destination volume is set, this type of storage apparatus statically allocates a difference management table on a memory of the storage apparatus only for the capacity of the volume so that only the difference can be duplicated. This difference management table has a bitmap structure and can store whether there is a difference in a unit of a certain capacity per bit.

PTL 2 discloses a difference bitmap management method which achieves reduction in the amount of memory that the above difference bitmap needs.

PTL 1: Japanese Patent Kokai Publication No. JP2006-251937A

PTL 2: Japanese Patent Kokai Publication No. JP2006-331100A

### SUMMARY

The following analysis has been made by the present inventor. If the unit of the capacity for one bit (the unit for managing the difference) in the above difference management table is set to be small, the difference can be managed more finely, and unnecessary data copying can be reduced. However, if a duplication target volume is large, a larger difference management table is needed. As a result, the difference management table could not be allocated due to insufficiency in the memory. To solve this problem, the memory can be expanded virtually by using a disk. However, there is a problem in that the swapping processing between the disk and the memory can significantly affect the input-output performance of the storage.

Conversely, if the unit of the capacity for one bit in the difference management table is set to be large, a large-scale volume can be duplicated with a small memory capacity. However, since the amount of data to be duplicated is increased, the load inside the storage apparatus is increased, and the input-output performance is affected. In addition, if duplication is performed with a storage apparatus connected to a network, a costly network line is needed for transfer of a large amount of data.

PTL 2 adopts a method in which a difference management table has a hierarchical structure. In this method, when all the bitmap data in an entry on a second layer matches a predetermined value, the predetermined value is set in a representative bit of an entry in a first layer in the corresponding difference management table. In addition, the absence of the entry is stored. In this way, the memory capacity for the second-layer bitmap is reduced.

However, PTL 2 does not disclose what value needs to be set as the unit of the capacity for one bit. Thus, if the scale of a duplication target volume is large, similar problems could occur. Namely, a large difference management table could be needed, and more unnecessary copying could be performed, for example.

It is an object of the present disclosure to provide a difference management apparatus, a storage system, a difference management method, and a program that contribute to improving the efficiency of generation of difference data between two pieces of data and the efficiency of duplication using this difference data.

According to a first aspect, there is provided a difference management apparatus that manages a difference(s) by using a first difference management table and a second difference management table. The first difference management table manages first difference map information that indicates a location(s) of occurrence of a difference(s) in a first management unit obtained by dividing a duplication target area in a storage apparatus. In the second difference management table, when an area-wide difference(s) has not occurred in the first management unit of the first difference management table, second difference map information associated with the first difference map information in the first difference management table is managed, the second difference map information indicating a location(s) of occurrence of a difference(s) in the first difference map information in a second management unit finer than the first management unit. This difference management apparatus further includes a difference manager which updates, when data in the storage apparatus is updated, difference map information that corresponds to updated locations in the first and second difference management tables, removes, if the second difference map information indicates an area-wide difference(s) as a result of an update of the second difference map information in the second difference management table, an entry(ies) corresponding to the second difference map information in which the area-wide difference(s) has occurred from the second difference management table, and removes a correspondence relationship(s) with the second difference management table in the first difference map information.

According to a second aspect, there is provided a storage system, including: the above difference management apparatus; and a disk device(s) included in the storage apparatus.

According to a third aspect, there is provided a difference management method using a certain difference management apparatus. This difference management apparatus includes a first difference management table which manages first difference map information that indicates a location(s) of occurrence of a difference(s) in a first management unit obtained by dividing a duplication target area in a storage apparatus and a second difference management table in which, when an area-wide difference(s) has not occurred in the first management unit of the first difference management table, an entry(ies) for managing second difference map information associated with the first difference map information in the first difference management table is generated, the second difference map information indicating a location(s) of occurrence of a difference(s) in the first difference map information in a second management unit finer than the first management unit. The difference management method includes: updating, when data in the storage apparatus is updated, difference map information that corresponds to updated locations in the first and second difference management tables; and removing, if the second difference map information indicates an area-wide difference(s) as a result of an update of the second difference map information in the second difference management table, an entry(ies) corresponding to the second difference map information in which the area-wide difference(s) has occurred from the second difference management table and removing a correspondence relationship(s) with the second difference management table in the first difference map information. The present method is tied to a particular machine, which is a difference management apparatus that manages a difference(s) by using the first and second difference management tables.

According to a fourth aspect, there is provided a non-transitory computer-readable storage medium that records a program, causing a computer, which holds a first difference management table which manages first difference map information that indicates a location(s) of occurrence of a difference(s) in a first management unit obtained by dividing a duplication target area in a storage apparatus and a second difference management table in which, when an area-wide difference(s) has not occurred in the first management unit of the first difference management table, an entry(ies) for managing second difference map information associated with the first difference map information in the first difference management table is generated, the second difference map information indicating a location(s) of occurrence of a difference(s) in the first difference map information in a second management unit finer than the first management unit, to perform processings for: updating, when data in the storage apparatus is updated, difference map information that corresponds to updated locations in the first and second difference management tables; and removing, if the second difference map information indicates an area-wide difference(s) as a result of an update of the second difference map information in the second difference management table, an entry(ies) corresponding to the second difference map information in which the area-wide difference(s) has occurred from the second difference management table and removing a correspondence relationship(s) with the second difference management table in the first difference map information. The program can be recorded in a computer-readable (non-transient) storage medium. Namely, the present disclosure can be embodied as a computer program product.

The meritorious effects of the present disclosure are summarized as follows.

According to the present disclosure, the efficiency of generation of difference data between two pieces of data and the efficiency of duplication by using this difference data can be improved. Namely, the present disclosure converts the individual difference management apparatus described in the above Background into a difference management apparatus having dramatically improved performance in the generation of difference data and the duplication using this difference data.

### BRIEF DESCRIPTION OF THE DRAWINGS

FIG. 1 illustrates a configuration according to an exemplary embodiment of the present disclosure.

FIGS. 2A-2C illustrate changes in a second difference management table in a difference management apparatus according to the exemplary embodiment of the present disclosure.

FIGS. 3D-3F illustrate changes in the second difference management table in the difference management apparatus according to the exemplary embodiment of the present disclosure.

FIG. 4 illustrates a configuration according to a first exemplary embodiment of the present disclosure.

FIG. 5 illustrates an example of a configuration of a static difference management table according to the first exemplary embodiment of the present disclosure.

FIG. 6 illustrates an example of a configuration of a dynamic difference management table according to the first exemplary embodiment of the present disclosure.

FIG. 7 schematically illustrates a relationship among a volume space, the static difference management table, and the dynamic difference management table according to the first exemplary embodiment of the present disclosure.

FIG. 8 is a flowchart illustrating an operation (initial settings) of a storage apparatus according to the first exemplary embodiment of the present disclosure.

FIG. 9 is a flowchart illustrating an operation (difference management processing) of the storage apparatus according to the first exemplary embodiment of the present disclosure.

FIG. 10 is a continued flowchart illustrating steps performed after A and B in FIG. 9.

FIG. 11 is a flowchart illustrating an operation (upon data duplication) of the storage apparatus according to the first exemplary embodiment of the present disclosure.

### PREFERRED MODES

First, an outline of an exemplary embodiment of the present disclosure will be described with reference to drawings. The reference characters that denote various elements in the following outline are merely used as examples for the sake of convenience to facilitate understanding of the present disclosure. Therefore, the reference characters are not intended to limit the present disclosure to the illustrated modes. An individual connection line between blocks in the individual drawing to be referred to in the following description signifies both one-way and two-way directions. An individual arrow schematically illustrates the principal flow of a signal (data) and does not exclude bidirectionality.

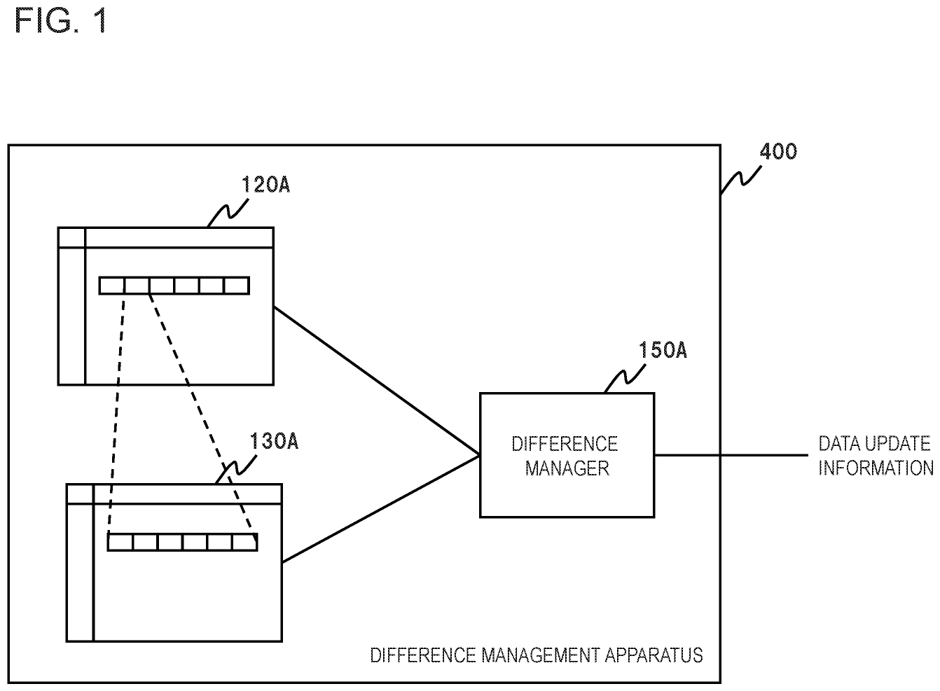

As illustrated in FIG. 1, an exemplary embodiment of the present disclosure can be realized by a difference management apparatus 400 that includes: a storage device capable of storing a first difference management table 120A and a second difference management table 130A; and a processor that configures a difference manager 150A.

More specifically, the first difference management table 120A is used for managing first difference map information that indicates the location(s) of occurrence of a difference(s) in a first management unit obtained by dividing a duplication target area in a storage.

The second difference management table 130A is configured by a dynamic table to which a new entry(s) is added when an area-wide difference(s) has not occurred in the first management unit of the first difference management table 120A. The entry(s) is used for managing second difference map information associated with the first difference map information in the first difference management table 120A. Specifically, the second difference map information indicates the location(s) of occurrence of a difference(s) in the first difference map information in a second management unit finer than the first management unit.

When data in the storage is updated, the difference manager 150A updates the difference map information that corresponds to the updated locations in the first and second difference management tables. In addition, as a result of an update of the second difference map information in the second difference management table 130A, if the difference map information indicates an area-wide difference, the difference manager 150A performs the following processing. Specifically, the difference manager 150A removes, from the second difference management table 130A, an entry corresponding to the second difference map information in which the area-wide difference has occurred and removes the correspondence relationship with the second difference management table in the first difference map information. More preferably, the difference manager 150A may store information indicating that an area-wide difference has occurred in the corresponding entry in the first difference map information in the first difference management table 120A.

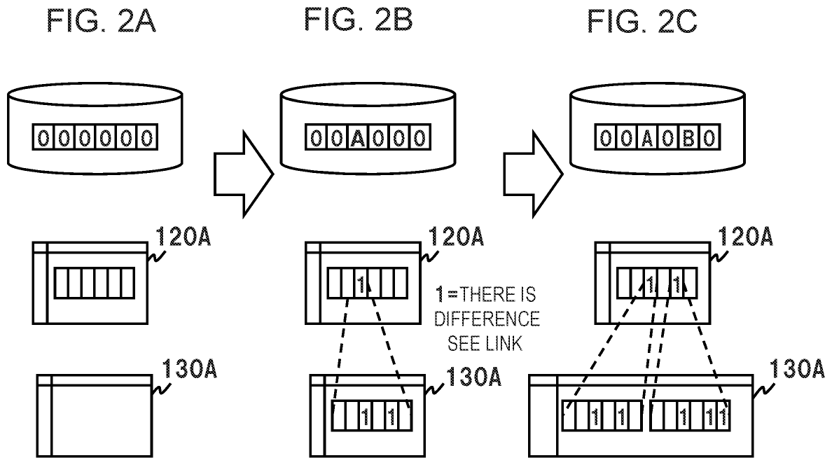

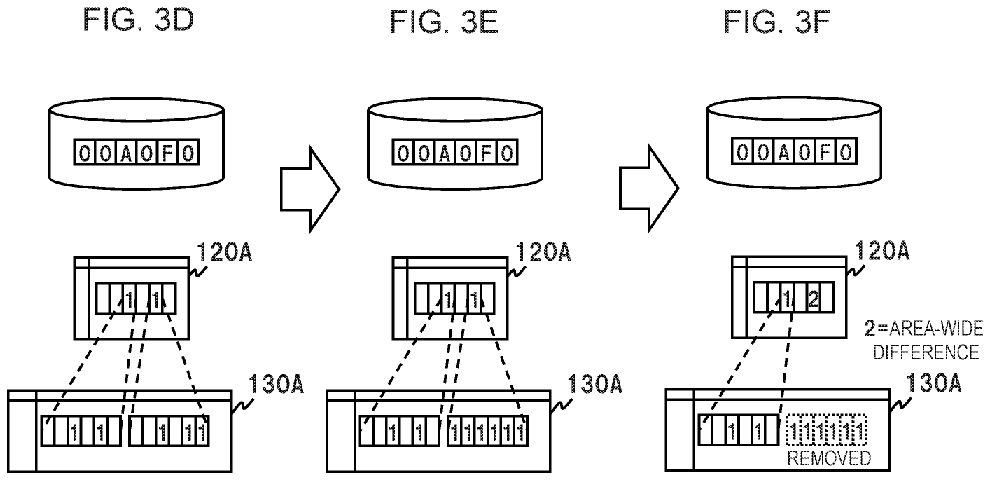

Changes in the second difference management table 130A in the above difference management apparatus will be described with reference to FIGS. 2A-2C and 3D-3F. The upper portion of FIGS. 2A-2C schematically illustrates a duplication source storage and individual duplication target areas obtained by dividing the duplication source storage. In an initial state in FIG. 2A, only the difference map information corresponding to the areas in the duplication source storage has been generated in the first difference management table 120A. At this point, no entries holding difference map information have been generated in the second difference management table 130A.

Next, as illustrated in FIG. 2B, the duplication source storage is updated (for convenience, this example assumes that data “0” located in the third area from the left has been rewritten to data “A”). In this case, the difference manager 150A sets a bit “1” indicating that a difference has occurred in the corresponding location in the first difference map information in the first difference management table 120A. In addition, the difference manager 150A adds a new entry in the second difference management table 130A and creates second difference map information indicating the location of the occurrence of the difference in the first difference map information. As illustrated in the lower portion of FIG. 2B, bits determining the storage data to be duplicated as a result of the update to data “A” are set in this second difference map information.

Next, likewise, as illustrated in FIG. 2C, the duplication source storage is updated (for convenience, this example assumes that data “0” located is in the fifth area from the left has been rewritten to data “B”). In this case, too, the difference manager 150A sets a bit “1” indicating that a difference has occurred in the corresponding location in the first difference map information in the first difference management table 120A. In addition, the difference manager 150A adds a new entry in the second difference management table 130A and creates second difference map information indicating the location of the occurrence of the difference in the first difference map information. As illustrated in the lower portion of FIG. 2C, bits determining the storage data to be duplicated as a result of the update to data “B” are set in this second difference map information.

When the data is duplicated in this state, only the locations indicated in the second difference management table 130A are duplicated. As described above, since the data in the second difference management table 130A is recorded in the second management unit finer than the first management unit, the amount of data to be copied can be reduced.

Next, as illustrated in FIG. 3D, the duplication source storage is updated (for convenience, this example assumes that the data “B” located in the fifth area from the left has been rewritten to data “F”). In this case, as illustrated in FIG. 3E, the difference manager 150A updates the second difference map corresponding to an existing entry in the second difference management table 130A. As illustrated in FIG. 3E, if an area-wide difference has occurred in the second difference map information as a result of the above updating, the difference manager 150A performs the following processing. Specifically, as illustrated in FIG. 3F, the difference manager 150A removes the entry corresponding to the area-wide difference from the second difference management table 130A and removes the correspondence relationship with the second difference management table in the first difference map information. In addition, in the example in FIG. 3F, the difference manager 150A stores information “2”, which indicates that the occurrence of the area-wide difference in the corresponding entry in the first difference map information in the first difference management table 120A. In this way, when the data is duplicated, the data duplication locations can be determined without checking whether the correspondence relationship with the second difference management table in the first difference map information has been removed.

When the data is duplicated in the state in FIG. 3F, only the locations specified by the first difference management table 120A corresponding to the data “F” and the second difference management table 130A corresponding to the data “A” need to be duplicated. As described above, since the data in the second difference management table 130A is stored in the second management unit finer than the first management unit, the amount of data to be copied can be reduced. In addition, since the difference manager 150A removes the entry corresponding to the area-wide difference from the second difference management table 130A, the size of the second difference management table 130A can be reduced.

As described above, the difference management apparatus according to the present disclosure reduces the size of the first difference management table by using the difference management map having a larger capacity unit corresponding to one bit (the unit for managing the difference). In addition, for a location(s) that needs detailed difference management, the difference management apparatus according to the present disclosure creates a necessary number of entries in the second difference management table. In this way, the present disclosure successfully reduces the waste in the duplication processing while reducing the size of the difference management tables.

### First Exemplary Embodiment

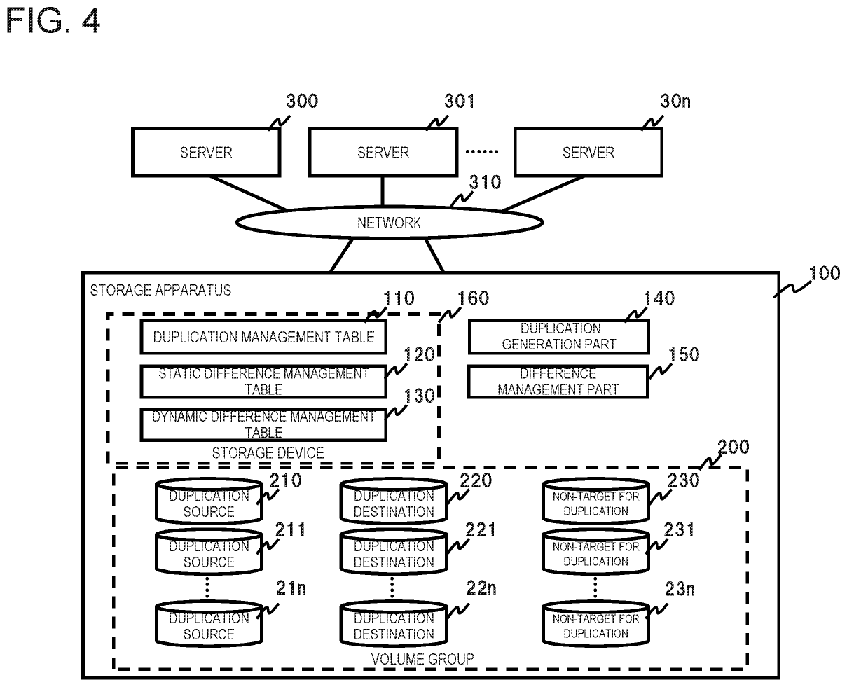

Next, a first exemplary embodiment of the present disclosure will be described in detail with reference to drawings. FIG. 4 illustrates a configuration according to the first exemplary embodiment of the present disclosure. As illustrated in FIG. 4, a plurality of servers 300 to 30n are connected to a storage apparatus 100 via a network 310.

The storage apparatus 100 processes input and output requests from the servers 300 to 30n. The storage apparatus 100 includes a volume group 200 that stores business data. A volume is a management unit such as a disk drive included in the storage apparatus 100. In the present exemplary embodiment, the following description assumes that attributes are given to the individual volumes based on the purposes of utilization of the individual volumes. For example, volumes 230 to 23n will be used as non-targets for duplication, which will not be duplicated. In contrast, volumes 210 to 21n will be used as duplication sources, and volumes 220 to 22n will be used as duplication destinations, which are duplication targets.

The storage apparatus 100 according to the present exemplary embodiment includes a duplication management table 110, a static difference management table 120, a dynamic difference management table 130, difference management part 150, and duplication generation part (duplication generator) 140. The duplication management table 110, the static difference management table 120, and the dynamic difference management table 130 are stored in a management storage device 160 in the storage apparatus 100.

The duplication management table 110 is used for storing a correspondence relationship(s) between at least one of the duplication sources 210 to 21n and at least one of the duplication destinations 220 to 22n and a duplication state(s). A copy generation management table disclosed in FIGS. 2 and 4 in PTL 1 may be used as the duplication management table 110.

The static difference management table 120 and the dynamic difference management table 130 are tables for storing a difference(s) between duplication source data and duplication destination data. and correspond to the above first and second difference management tables, respectively.

The difference management part 150 manages the difference between the data in the static difference management table 120 and the data in the dynamic difference management table 130. This management will be described in detail together with an operation according to the present exemplary embodiment.

The duplication generation part 140 refers to and updates the duplication management table 110 and duplicates a volume(s) in cooperation with the difference management part 150. Specifically, the duplication generation part 140 extracts a pair of duplication source and duplication destination from the duplication management table 110 and copies the data corresponding to the difference between the static difference management table 120 and the dynamic difference management table 130.

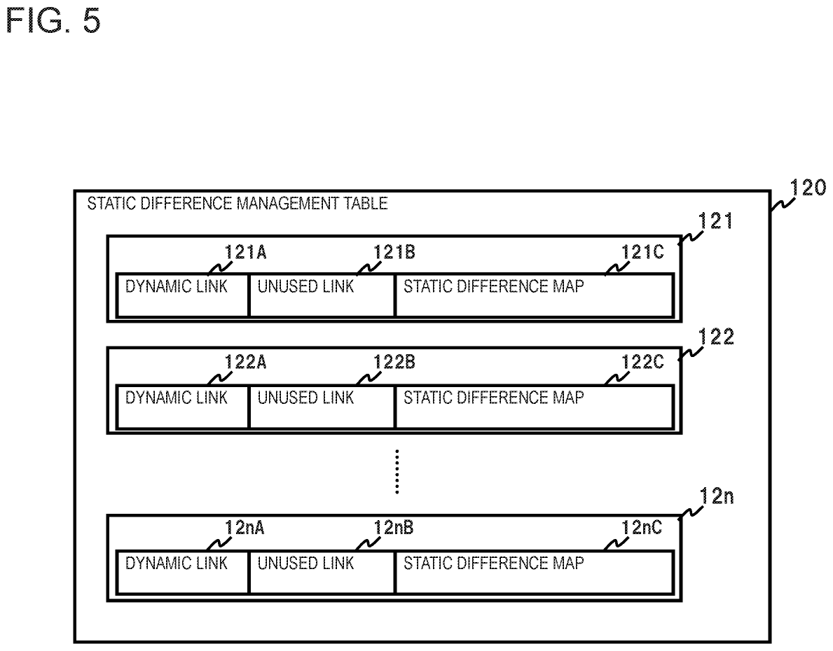

Next, the static difference management table 120 and the dynamic difference management table 130 will be described in detail with reference to drawings. FIG. 5 illustrates an example of a configuration of the static difference management table. This static difference management table 120 has an array configuration including elements (entries) 121 to 12n. The individual elements have fields for storing dynamic links 121A to 12nA, unused links 121B to 12nB, and static difference maps 121C to 12nC. The dynamic links 121A to 12nA indicate identification information about the dynamic difference management table 130. The unused links 121B to 12nB are used for list management of unused elements. The static difference maps 121C to 12nC indicate the locations of the differences between the duplication sources and the duplication destinations. The individual elements in the static difference management table 120 are generated in association with the individual areas obtained by dividing one of the duplication target volumes configured by the duplication source volumes 210 to 21n and will not be removed unless the configuration or the division number of the duplication target volume is changed. Therefore, this table is referred to as the static difference management table 120.

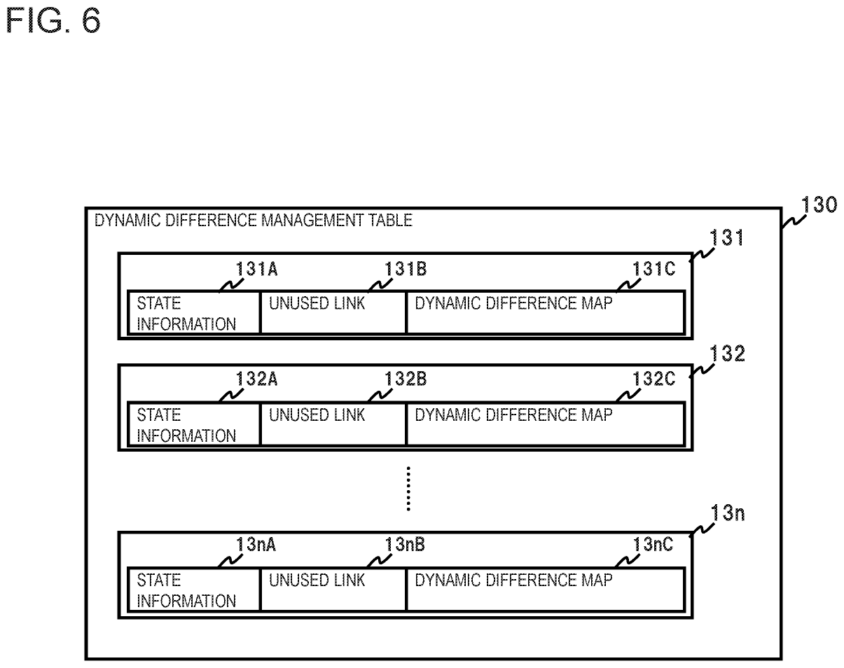

FIG. 6 illustrates an example of a configuration of the dynamic difference management table 130. The dynamic difference management table 130 has an array configuration including elements (entries) 131 to 13n. The individual elements have fields for storing state information 131A to 13nA, unused links 131B to 13nB, and dynamic difference maps 131C to 13nC. The state information 131A to 13nA represents usage states. The unused links 131B to 13nB are used for list management of unused elements. The dynamic difference maps 131C to 13nC indicate the locations of the differences between the duplication sources and the duplication destinations. These elements in the dynamic difference management table 130 are generated when a difference map(s) finer than the static difference maps 121C to 12nC is needed. In addition, these elements in the dynamic difference management table 130 are removed as soon as they become unnecessary. Thus, this table is referred to as the dynamic difference management table 130.

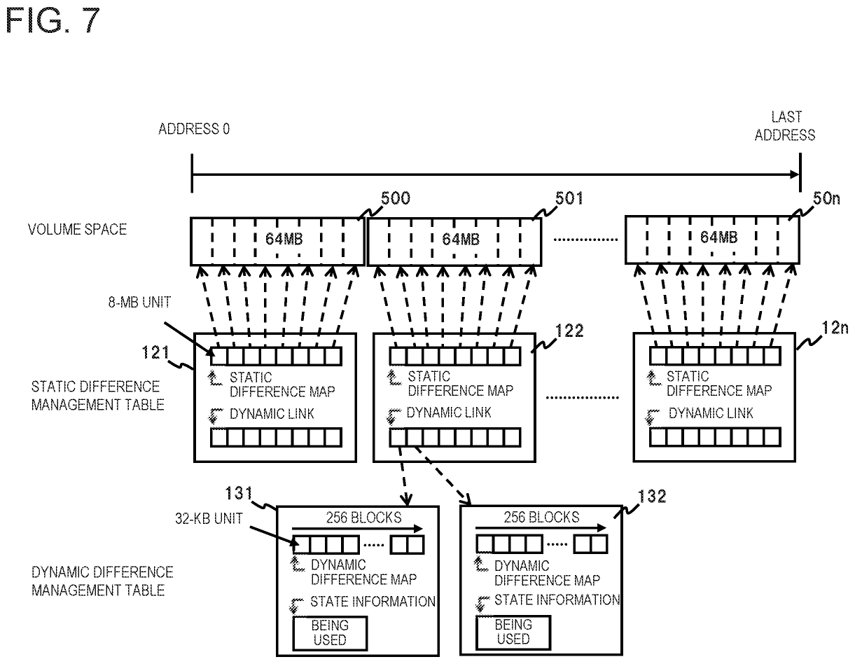

Next, a relationship among a volume space, the static difference management table 120, and the dynamic difference management table 130 will be described with reference to FIG. 7. FIG. 7 schematically illustrates the relationship among a volume space, the static difference management table, and the dynamic difference management table according to the present exemplary embodiment. In the example in FIG. 7, the duplication target volume space is divided into blocks of 64 MB (megabytes) (500 to 50n), and the elements 121 to 12n in the static difference management table are allocated to the respective blocks. In addition, the static difference map of the individual element in the static difference management table 120 is divided into 8 blocks (management units). Thus, the individual static difference map in the static difference management table 120 in FIG. 7 can store a difference that has occurred in an area of 64 MB in granularity of 8 MB.

As mentioned above, depending on the size of a volume handled by the storage apparatus 100 or the performance of the storage apparatus, there are cases in which a large amount of data needs to be copied when a unit of 8 MB is used. Thus, in the present exemplary embodiment, the dynamic difference management table 130 can dynamically be allocated to the elements in the static difference management table 120 so that a difference(s) can be managed in a finer unit. In the example in FIG. 7, the dynamic difference map of the individual element in the dynamic difference management table 130 is divided into 256 blocks (management units). Thus, the individual dynamic difference map in the dynamic difference management table 130 in FIG. 7 can finely store a difference that has occurred in an area of 8 MB in granularity of 32 KB (kilobytes).

FIG. 7 illustrates a state in which the elements 131 and 132 in the dynamic difference management table are respectively allocated to the first two blocks indicating differences that have occurred on the static difference map of the element 122 in the static difference management table. In this way, the amount of data to be copied can be reduced to 32 KB*2=64 KB, not the whole 8-MB block on the static difference map.

An individual one of the parts (processing means) in the difference management apparatus 400 and the storage apparatus 100 illustrated in FIGS. 1 and 4 may be realized by a computer program that causes a processor mounted on the corresponding apparatus to use its hardware and perform the corresponding processing described above.

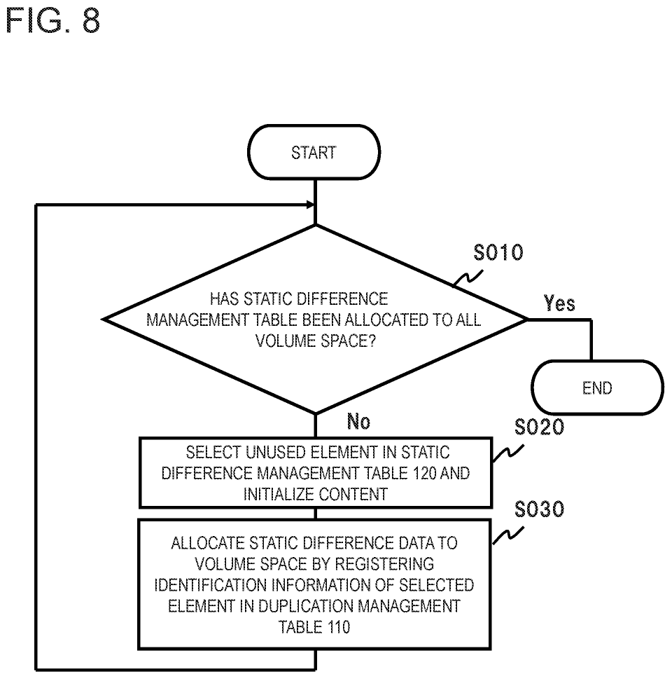

Next, an operation according to the present exemplary embodiment will be described in detail with reference to drawings. FIG. 8 is a flowchart illustrating an operation (initial settings) of the storage apparatus according to the first exemplary embodiment of the present disclosure. Specifically, FIG. 8 illustrates processing of the allocation (initial settings) of the static difference management table 120. The difference management part 150 performs this processing when a correspondence relationship between a duplication source volume and a duplication destination volume is set.

First, the difference management part 150 determines whether the static difference management table 120 has already been allocated to the duplication target volume space (step S010). If there is an area where the static difference management table 120 has not yet been allocated, the difference management part 150 selects and initializes an unused element in the static difference management table (step S020). Next, the difference management part 150 registers identification information of the selected element in the duplication management table 110 to allocate the selected element to the corresponding volume space (step S030). When the difference management part 150 has allocated the static difference management table 120 to all the space of the target volume (Yes in step S010), the difference management part 150 ends the processing. While the difference management part 150 performs the processing in the example in FIG. 8, the initialization of the static difference management table 120 and the allocation to the duplication management table 110 may be performed by using a program that executes processing equivalent to that illustrated in FIG. 8.

By performing the above processing, the allocation of the static difference management table 120 illustrated in the middle portion of FIG. 7 to the volume space is completed.

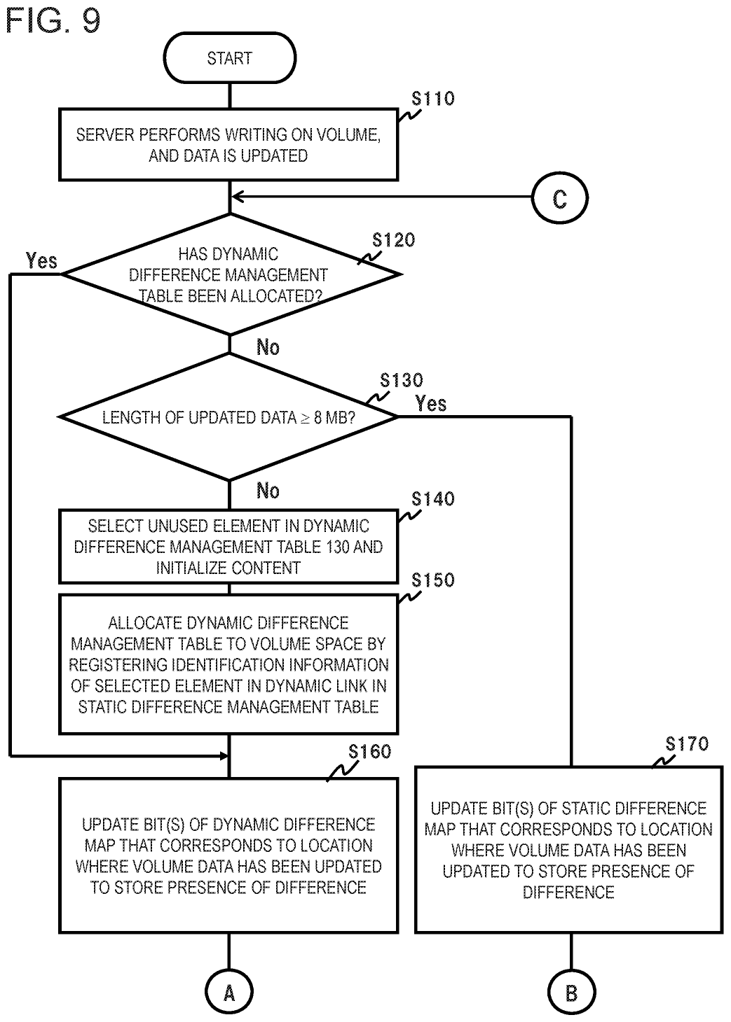

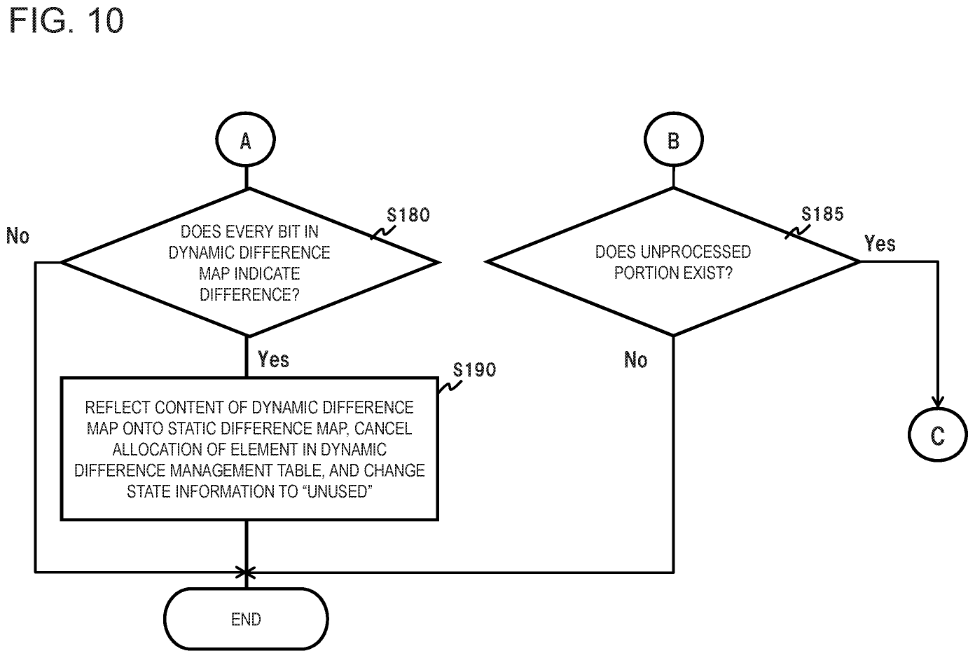

Next, an operation performed by the difference management part 150 when data of a duplication target volume is updated will be described. FIGS. 9 and 10 are a flowchart illustrating an operation (difference management processing) of the storage apparatus according to the present exemplary embodiment.

The processing in FIGS. 9 and 10 is started when any one of the servers 300 to 30n connected to the storage apparatus 100 performs writing on a duplication target volume and data is updated. First, the difference management part 150 determines whether the dynamic difference management table has been allocated to the updated portion of the volume space (step S120). If the dynamic difference management table has been allocated, the processing proceeds to step S160.

If the dynamic difference management table has not yet been allocated, the difference management part 150 checks the length of the data updated by the server and determines whether a new element(s) in the dynamic difference management table 130 needs to be allocated. In the present exemplary embodiment, the difference management part 150 determines whether the data length is equal to or more than 8 MB, namely, equal to or more than the unit of the difference map in the static difference management table 120 (step S130).

As a result of the determination performed in step S130, if the data length is smaller than 8 MB, the difference management part 150 selects an unused element in the dynamic difference management table 130 and initializes the content (step S140).

Next, the difference management part 150 allocates the dynamic difference management table 130 by registering identification information of the selected element in a corresponding one of the dynamic links 121A to 12nA of the corresponding element in the static difference management table that correspond to the updated portion of the volume space (step S150).

Next, the difference management part 150 updates the corresponding bit(s) of the dynamic difference map that corresponds to the updated portion to store the presence of the difference at the corresponding location (step S160).

Next, the difference management part 150 determines whether a difference is stored in every bit in the dynamic difference map updated in step S160 (in the example in FIG. 7, 32 KB*256=8 MB) (step S180 in FIG. 10). If a difference is not stored in every bit, the difference management part 150 ends the processing.

In contrast, as a result of the determination performed in step S180, if a differences is stored in every bit, the corresponding element in the dynamic difference management table is not necessary. Thus, the difference management part 150 reflects the content of the dynamic difference map onto the static difference map, cancels the allocation of this element in the dynamic difference map table, and changes the value in the corresponding one of the state information 131A to 13nA of the corresponding element to “unused” (step S190).

In step S130, if the data length is equal to or more than 8 MB, the difference management part 150 updates a bit(s) of a static difference map that corresponds to the updated portion to store the presence of the difference (step S170). In addition, the difference management part 150 checks whether any unprocessed portion onto which the update of the static difference map has not been reflected exists in the data 8 MB or more (step S185 in FIG. 10). As a result of this determination, if an unprocessed portion exists, the processing returns to step S120 in FIG. 9 and continues the updating of the difference map (from C in FIG. 10 to C in FIG. 9).

The above processing is performed every time writing on a duplication target volume is performed and data is updated. In this way, the contents of the differences are stored with the least number of difference management maps. In addition, at predetermined timing, based on the differences stored in the static difference management table 120 and the dynamic difference management table 130, the corresponding data is copied from the duplication source to the duplication destination.

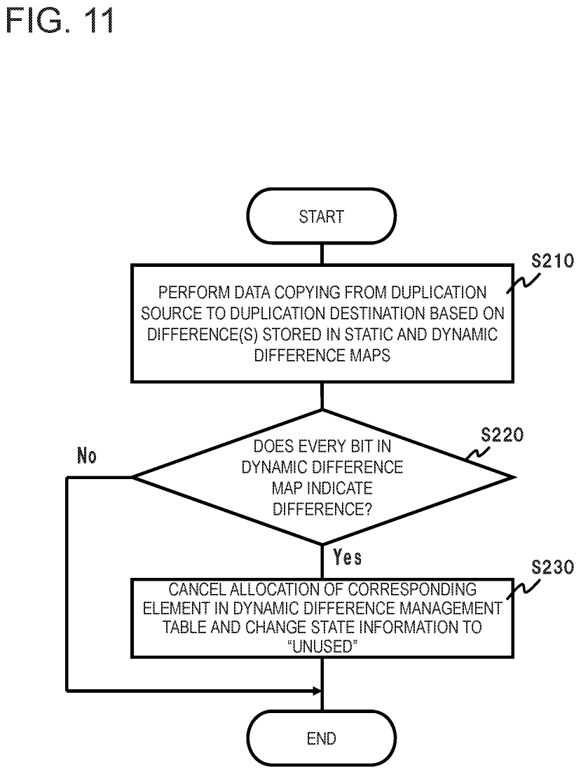

FIG. 11 illustrates an operation performed when the storage apparatus 100 according to the present exemplary embodiment performs data duplication. The duplication generation part 140 refers to the static difference management table 120 and the dynamic difference management table 130, determines difference data, and copies the data (step S210). In addition, the duplication generation part 140 resets the bit(s) corresponding to the portion(s) that has been duplicated in the difference management maps in the static difference management table 120 and the dynamic difference management table 130.

Every time the duplication generation part 140 performs data copying, the difference management part 150 checks the corresponding element(s) in the dynamic difference management table 130 that is allocated to the volume space in which the data copying has been performed. Specifically, the difference management part 150 checks whether every bit in the corresponding dynamic difference map indicates a difference (step S220). As a result of the checking, if every bit indicates a difference, the difference management part 150 cancels the allocation of the corresponding element in the dynamic difference management table 130 and changes the value of the corresponding one of the state information 131A to 13nA in this element to “unused” (step S230).

In contrast, if there is any bit indicating a difference left in the dynamic difference map, the difference management part 150 ends the processing. As a result, since the allocation of this element in the dynamic difference management table 130 is maintained, the data copying and the determination of whether the corresponding element in the dynamic difference management table 130 is needed are repeated.

As described above, according to the present exemplary embodiment, it is possible to generate a duplication of a large-scale volume efficiently and quickly while effectively using the limited memory capacity of the storage apparatus. This is because two difference maps having two different granularities are prepared. Namely, a difference map having a large management unit and a difference map having a small management unit are prepared. With this configuration, even if duplication target volumes are large, the data difference between the volumes can be managed within the limited memory of the storage apparatus.

In addition, the present exemplary embodiment can eliminate the problem of the insufficient memory for the difference management and the impact on the input-output performance caused by virtually expanding a memory using a disk, the problems having been discussed in the background. In addition, since finer difference management is possible, the number of differences is not increased unnecessarily, and the load on the storage apparatus is not increased unnecessarily by data copying. In addition, even when duplication is performed with a storage apparatus connected to a network, a costly network with a high band is not needed.

While an individual exemplary embodiment of the present invention has thus been described, the present invention is not limited thereto. Further variations, substitutions, or adjustments can be made without departing from the basic technical concept of the present invention. For example, the configurations of the networks, the configurations of the elements, and the configurations of the tables illustrated in the drawings have been used only as examples to facilitate understanding of the present invention. Namely, the present invention is not limited to the configurations illustrated in the drawings.

While the storage apparatus 100 has a function as the difference management apparatus in the above exemplary embodiment, the storage apparatus and the difference management apparatus may be configured as two separate apparatuses.

In addition, in the above exemplary embodiment, the granularity (the first management unit) of the difference management map in the first difference management table 120A is 8 MB, and the granularity (the second management unit) of the difference management map in the second difference management table 130A is 32 KB. However, this combination of the management units is merely an example. As long as the second management unit is finer than the first management unit, there are no constraints on the values. For example, the granularity (second management unit) of the difference management map in the second difference management table 130A may be set to be half of the granularity (first management unit) of the difference management map in the first difference management table 120A. However, it is preferable that the second management unit be a size obtained by dividing the first management unit by a predetermined number, in view of the size of a volume and processing capacity of a common storage apparatus as well as a data update pattern.

In addition, in the above exemplary embodiment, two difference maps having two different granularities, namely, a difference map having a large management unit and a difference map having a small management unit, are prepared. However, three or more difference maps having three or more levels may be prepared to perform step-by-step management. For example, between the static difference management table 120 and the dynamic difference management table 130 in FIG. 7, a third difference management table (a second dynamic difference management table) holding a difference management map having a medium granularity (for example, 512 KB) may be arranged.

Finally, suitable modes of the present invention will be summarized.

### First Mode

(See the difference management apparatus according to the above first aspect)

### Second Mode

It is preferable that the second management unit of the above difference management apparatus be a size obtained by dividing the first management unit by a predetermined number.

### Third Mode

The above difference management apparatus may further include: a duplication management table in which a duplication source(s) and a duplication destination(s) in the storage apparatus are associated with each other; and a duplication generation part that duplicates data by referring to the duplication management table and the first and second difference management tables.

### Fourth Mode

The difference manager of the above difference management apparatus may remove an unnecessary entry(ies) from the second difference management table after data is duplicated.

### Fifth Mode

(See the storage system according to the above second aspect.)

### Sixth Mode

(See the difference management method according to the above third aspect.)

### Seventh Mode

(See the program according to the above fourth aspect.)

The above fifth to seventh modes can be expanded in the same way as the first mode is expanded to the second to fourth modes.

The disclosure of each of the above PTLs is incorporated herein by reference thereto. Variations and adjustments of the exemplary embodiment(s) and examples are possible within the scope of the overall disclosure (including the claims) of the present invention and based on the basic technical concept of the present invention. Various combinations and selections of various disclosed elements (including the elements in the claims, exemplary embodiment(s), examples, drawings, etc.) are possible within the scope of the disclosure of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

100 storage apparatus

110 duplication management table

120 static difference management table

120A first difference management table

121 to 12n, 131 to 13n element (entry)

121A to 12nA dynamic link

121B to 12nB, 131B to 13nB unused link

121C to 12nC static difference map

130 dynamic difference management table

130A second difference management table

131A to 13nA state information

131C to 13nC dynamic difference map

140 duplication generation part (duplication generator)

150 difference management part

150A difference manager

160 storage device

200 volume group

210 to 21n duplication source (volume)

220 to 22n duplication destination (volume)

230 to 23n non-target (volume) for duplication

300 to 30n server

310 network

400 difference management apparatus

500 to 50n duplication target volume space

What is claimed is:

1. A difference management apparatus, comprising:
a first difference management table which manages first difference map information that indicates a location(s) of occurrence of a difference(s) in a first management unit obtained by dividing a duplication target area in a storage apparatus;
a second difference management table in which, when an area-wide difference(s) has not occurred in the first management unit of the first difference management table, an entry(ies) for managing second difference map information associated with the first difference map information in the first difference management table is generated, the second difference map information indicating a location(s) of occurrence of a difference(s) in the first difference map information in a second management unit finer than the first management unit; and
a difference manager which updates, when data in the storage apparatus is updated, difference map information that corresponds to updated locations in the first and second difference management tables, removes, if the second difference map information indicates an area-wide difference(s) as a result of an update of the second difference map information in the second difference management table, an entry(ies) corresponding to the second difference map information in which the area-wide difference(s) has occurred from the second difference management table, and removes a correspondence relationship(s) with the second difference management table in the first difference map information.

2. The difference management apparatus according to claim 1; wherein the second management unit is a size obtained by dividing the first management unit by a predetermined number.

3. The difference management apparatus according to claim 1, comprising:
a duplication management table in which a duplication source(s) and a duplication destination(s) in the storage apparatus are associated with each other; and
a duplication generation part that duplicates data by referring to the duplication management table and the first and second difference management tables.

4. The difference management apparatus according to claim 1; wherein the difference manager removes an unnecessary entry(ies) from the second difference management table after data is duplicated.

5. A storage system, comprising:
the difference management apparatus according to claim 1; and
a disk device(s) included in the storage apparatus.

6. A difference management method, comprising:
providing a difference management apparatus,
which includes a first difference management table which manages first difference map information that indicates a location(s) of occurrence of a difference(s) in a first management unit obtained by dividing a duplication target area in a storage apparatus and a second difference management table in which, when an area-wide difference(s) has not occurred in the first management unit of the first difference management table, an entry(ies) for managing second difference map information associated with the first difference map information in the first difference management table is generated, the second difference map information indicating a location(s) of occurrence of a difference(s) in the first difference map information in a second management unit finer than the first management unit,
causing the difference management apparatus to update, when data in the storage apparatus is updated, difference map information that corresponds to updated locations in the first and second difference management tables; and
causing the difference management apparatus to remove, if the second difference map information indicates an area-wide difference(s) as a result of an update of the second difference map information in the second difference management table, an entry(ies) corresponding to the second difference map information in which the area-wide difference(s) has occurred from the second difference management table and remove a correspondence relationship(s) with the second difference management table in the first difference map information.

7. A non-transitory computer-readable storage medium that records a program, causing a computer, which holds a first difference management table which manages first difference map information that indicates a location(s) of occurrence of a difference(s) in a first management unit obtained by dividing a duplication target area in a storage apparatus and a second difference management table in which, when an area-wide difference(s) has not occurred in the first management unit of the first difference management table, an entry(ies) for managing second difference map information associated with the first difference map information in the first difference management table is generated, the second difference map information indicating a location(s) of occurrence of a difference(s) in the first difference map information in a second management unit finer than the first management unit, to perform processings for:
updating, when data in the storage apparatus is updated, difference map information that corresponds to updated locations in the first and second difference management tables; and
removing, if the second difference map information indicates an area-wide difference(s) as a result of an update of the second difference map information in the second difference management table, an entry(ies) corresponding to the second difference map information in which the area-wide difference(s) has occurred from the second difference management table and removing a correspondence relationship(s) with the second difference management table in the first difference map information.

8. The difference management apparatus according to claim 2, comprising:
a duplication management table in which a duplication source(s) and a duplication destination(s) in the storage apparatus are associated with each other; and
a duplication generator that duplicates data by referring to the duplication management table and the first and second difference management tables.

9. The difference management apparatus according to claim 2; wherein the difference manager removes an unnecessary entry(ies) from the second difference management table after data is duplicated.

10. The difference management apparatus according to claim 3; wherein the difference manager removes an unnecessary entry(ies) from the second difference management table after data is duplicated.

11. The storage system according to claim 5; wherein the second management unit is a size obtained by dividing the first management unit by a predetermined number.

12. The storage system according to claim 5, comprising:
a duplication management table in which a duplication source(s) and a duplication destination(s) in the storage apparatus are associated with each other; and
a duplication generator that duplicates data by referring to the duplication management table and the first and second difference management tables.

13. The storage system according to claim 5; wherein the difference manager removes an unnecessary entry(ies) from the second difference management table after data is duplicated.
